(19) United States
(12) Patent Application Publication
(10) Pub. No.: US 2004/0134116 A1
(43) Pub. Date: Jul. 15, 2004

(54) Combination golf putter and telescopic fishing pole

(76) Inventor: Stephen William Axelrod, Cedar Creek, TX (US)

Correspondence Address: Stephen W. Axelrod, 135 Wamel Way, Cedar Creek, TX, 78612, US

(21) Appl. No.: 10/339,987

(22) Filed: Jan. 13, 2003

(51) Int. Cl. A01K 87/06; A01K 87/00

(52) U.S. Cl. 43/22

(57) ABSTRACT

The attached disclosure describes the only functional golf club that contains a telescopic fishing pole within the club shaft. This single piece of equipment will allow someone to participate in the sport of golf, as well as, the sport of fishing. Prior attempts to combine a golf club with a fishing pole have only been attempted on a standard golf club shaft. This length does not provide for enough flex to adequately fight a sizable fish. In addition, the fishing portion of the apparatus has been predominately fixed to the golf apparatus thereby limiting the golfers ability to have full use of the golf apparatus. The device attached to this disclosure allows for the separation of the golf and fishing apparatus to give the owner an either or option.

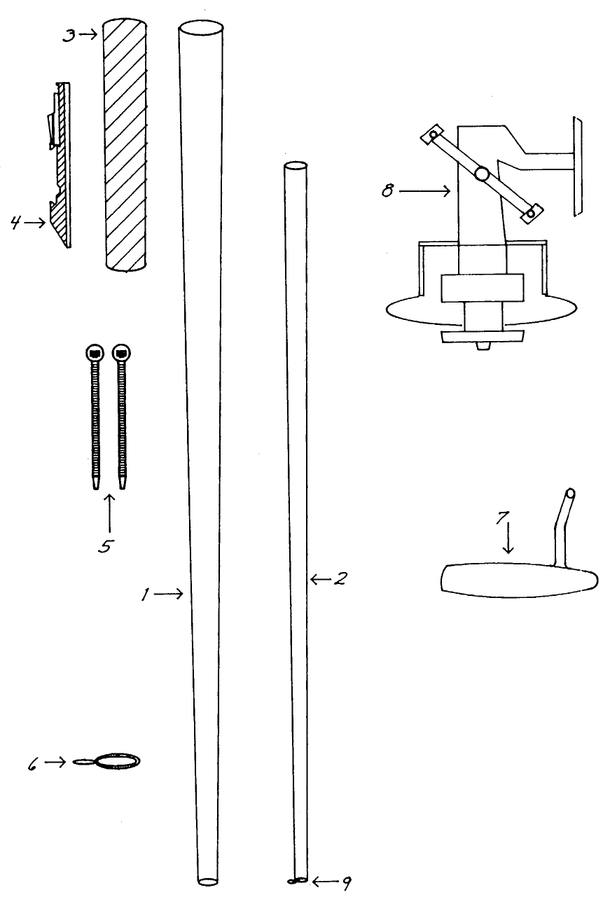

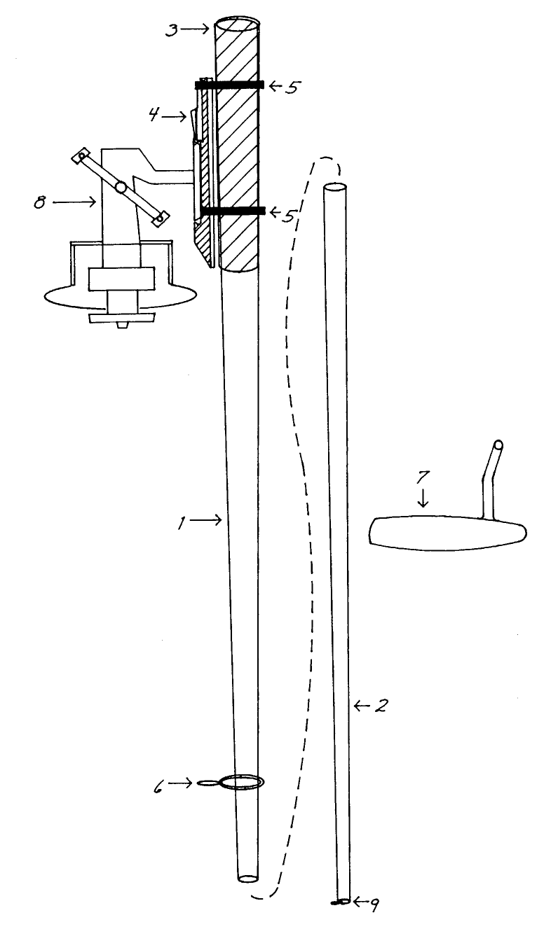

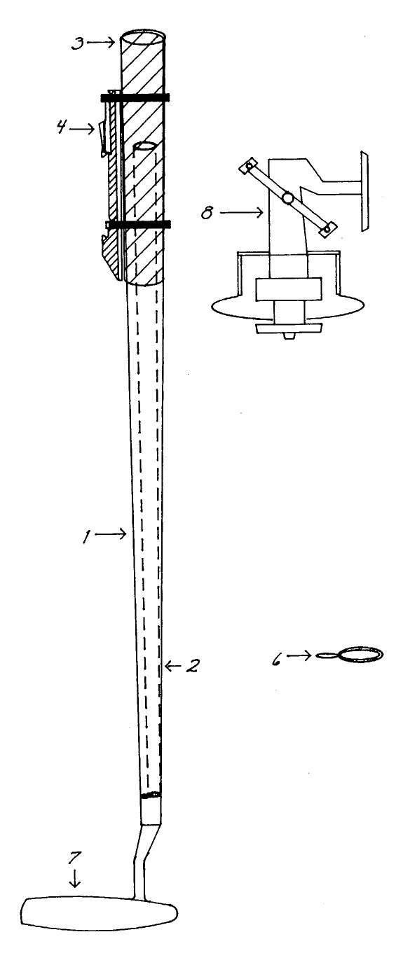

### CROSS-REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF THE INVENTION

This invention relates broadly to the field of golfing equipment and to the field of fishing equipment. Specifically, golf clubs and fishing poles.

It is widely known that many people that enjoy fishing also enjoy playing the game of golf. Additionally, many public and private golf courses contain numerous water hazards that are stocked with a variety of game fish. Unfortunately, with a golfers limited capacity to carry equipment on the golf course, carrying golf clubs in addition to fishing equipment is usually not advisable. Additionally, the length of standard fishing poles, if placed in a standard golf club bag, would most likely protrude well above the top of a standard golf cart, and could result in rod damage when driving through trees found around most golf courses.

Another problem with previous attempts to solve this problem (US-D266,939 Brammell, 11-1982), is that the fishing rod eyelets are fixed to the golf club shaft These could be easily damaged if the rod was placed into a standard golf club bag along with other golf clubs.

The apparatus of the present invention serves to eliminate the above problems by providing a single piece of equipment that can be used to serve both the needs of the golfer and the fisherman. Since the fishing pole is fully hidden within the golf club shaft, the golfer will not experience any distraction or interference from the fishing pole. In addition, the fishing reel and eyelets are detachable and can easily be stored in a standard golf club bag.

### BRIEF SUMMARY OF THE INVENTION

The attached disclosure describes the only functional golf club that contains a telescopic fishing pole within the club shaft. This single piece of equipment will allow someone to participate in the sport of golf, as well as, the sport of fishing. Prior attempts to combine a golf club with a fishing pole have only been attempted on a standard golf club shaft. This length does not provide for enough flex to adequately fight a sizeable fish. In addition, the fishing portion of the apparatus has been predominately fixed to the golf apparatus thereby limiting the golfers ability to have full use of the golf apparatus. The device attached to this disclosure allows for the separation of the golf and fishing apparatus to give the owner an either or option.

### BRIEF DESCRIPTION OF THE SEVERAL VIEWS OF THE DRAWING

Page 1/3 is a component view of the combined golf club and fishing rod showing the individual pieces.

Page 2/3 is a side view of the combined golf club and fishing rod showing the putter striking face removed from the shaft of the club, the telescopic rod shaft extended, and the fishing reel and mid-shaft eyelet attached.

Page 3/3 is a side view of the combined golf club and fishing rod showing the putter striking face attached to the shaft of the club and the fishing reel and detachable line eyelet removed.

### DETAILED FEATURE DESCRIPTION

Page 1/3 of the drawings represents the invention broken down to the individual components. The main club shaft 1 is a standard steel golf club shaft. The telescopic fishing rod blank 2 is a graphite shaft tip section as found on any standard telescopic fishing pole. The golf club grip 3 is a standard rubber grip. The adjustable fishing reel seat 4 is a graphite reel seat. The adjustable fishing reel seat 4 is attached on top of the golf club grip 3 using two standard plastic tie downs 5. The detachable line eyelet 6 is made of plastic. The golf putter head 7 is a standard metal putter head. The fishing reel 8 is a standard fishing reel.

Page 2/3 of the drawings represents the invention of the combined golf putter and telescopic fishing pole assembled as a fishing pole. The main club shaft 1 is a standard steel golf club shaft. The telescopic fishing rod blank 2 is inserted into the main club shaft 1 prior to placing a standard golf club grip 3 onto the main club shaft 1. The adjustable fishing reel seat 4 is then attached to the standard golf club grip 3 by using two standard plastic tie downs 5. At this point, you would slide the detachable line eyelet 6 up the main club shaft 1 until it is snug. The telescopic fishing rod blank 2 would then be allowed to slide out of the main club shaft 1 until it is fully extended. Then you would attach a standard fishing reel 8 to the adjustable fishing reel seat 4. Your fishing line would then be threaded through the detachable line eyelet 6 and then through the non-detachable line eyelet 9 which is attached to the end of the telescopic fishing rod blank 2. The golf putter head 7 would be set aside.

Page 3/3 of the drawings represents the invention assembled as a golf putter. The main club shaft 1 is a standard steel golf club shaft. The telescopic fishing rod blank 2 is inserted into the main club shaft 1 prior to placing a standard golf club grip 3 onto the main club shaft 1. The adjustable fishing reel seat 4 is then attached to the standard golf club grip 3 by using two standard plastic tie downs 5. The golf putter head 7 is attached over the end of the main club shaft 1 thereby keeping the telescopic fishing rod blank 2 inside the main club shaft 1. The detachable fishing line eyelet 6 and the standard fishing reel 8 would be set aside.

1. What I claim as my invention is a functional golf club that converts to a functional telescopic fishing pole, as shown.
